(19) United States
(12) Patent Application Publication
(10) Pub. No.: US 2014/0379432 A1
(43) Pub. Date: Dec. 25, 2014

(54) Method for Operating a Restaurant and its Food/Beverage Pricing

(71) Applicant: James Goldman, New York, NY (US)

(72) Inventor: James Goldman, New York, NY (US)

(21) Appl. No.: 13/925,885

(22) Filed: Jun. 25, 2013

(51) Int. Cl. G06Q 50/12; G06Q 30/02

(52) U.S. Cl. CPC G06Q 50/12; G06Q 30/0206
USPC 705/7.35

(57) ABSTRACT

A method for operating a restaurant and/or bar by charging patrons based on market pricing of actual food and beverages ordered and a seating charge per unit of time. A computer including memory, processor, and visual display mechanism is used to display the then current market prices for food and drinks, wherein a visual update of the market prices of specific food and drink items is provided. The market pricing is tied to the pricing of the food and/or beverages that the restaurant pays to its suppliers and/or to a market exchange. The bill for food and beverages includes an initial seating fee, which is a set price per patron per unit of time, and then an additional time seating fee is charged for any time after the initial unit of time expires. Seating charges depend upon time of day, day of week, season, and proximity to event or Holiday.

### FIELD OF THE INVENTION

The present invention relates to a new method for successfully operating or managing a restaurant and bar and for establishing pricing for food and drink in a restaurant and bar. Specifically, the present invention relates to a method for using volume purchase pricing, timing, and current (at the time of consumption) market conditions to determine prices of food and drinks sold within a restaurant and/or bar, along with a component of the pricing being based on duration of seating time of the patron(s) within the restaurant. The present invention provides a method for serving and selling quality food and drinks to patrons with the food often being substantially at market cost along with a component based on the time of day and the duration of stay of the patron within the restaurant, in comparison to conventional, significantly increased retail pricing now offered by restaurants where the purchase of the same is primarily based on a multiple of the wholesale cost of the food/beverage to the restaurant owner.

### BACKGROUND OF THE INVENTION AND DISCLOSURE

To stay in the restaurant business and, indeed, to actually make a profit, restaurants and other retail food and beverage serving establishments charge restaurant patrons significantly increased or marked-up prices for food or drinks being sold and consumed. The restaurant owner/operator has, of course, many expenses to cover in the operation, for example, rent, taxes, insurance, cost of personnel (wait staff, chef, bus boys, etc.) electric, etc. Ordinarily, the operation of a restaurant charges the patrons based on a significant increase or mark-up of the cost of the food and beverage being consumed. That mark up is expected to “cover” the cost of the food and beverage and the other costs and expenses in the operation of the restaurant. If income from patrons' consumption of food and beverages exceeds the expenses of operating the restaurant and the cost of the food and beverage from distributors or wholesales of the same, the restaurant is operating at a profit and will likely be “successful.” If the cost of operation and the cost of the food and beverages being consumed by the patrons is greater, on the other hand, than the income derived by patrons' purchasing of meals in the form of food and beverages, then the restaurant will be operating at a loss. Usually, unless other income from other sources (say at a hotel) is used to defer the losses of the restaurant, too many weeks, months or years of losses will result in the closing of the restaurant. Successful operation of a restaurant is important to its success and the profitability of the same to its owners. Even slight changes to the menu, pricing, cost of food and beverage, etc. can easily affect the success of a restaurant or its failure.

Generally, the restaurant owner/operator buys its food and beverages from a distributor or a wholesaler of the same. The owner generally pays a certain price to purchase quantity of food or beverages (and often liquor) from the wholesaler/distributor. The purchase price of the food and beverages is referred to herein as the cost of the goods or “the market price.” Then the owner/operator of the restaurant prepares and offers the food and drinks to its customers and, traditionally and conventionally, sells the same to the patrons/customers at a higher price for that same food or drink. The owner/operator has always considered this as the only way to stay in business, over time, since there are so many other expenses to be paid in the operation of the restaurant. Without a higher price being charged to the patrons for the consumed food and beverage, the owner/operator would be unprofitable and would quickly “close the doors” i.e., go out of business. At least that has been conventional thinking in the restaurant business for decades. The present invention provides a new model for operation of a restaurant. The owners/operators of a restaurant operated consistent with the present invention will charge its patrons based on the current (and visible to the patron) market price of the food and beverages ordered and consumed on the premises and, in addition, a fee based on the duration of time that the patron(s) remain on the premises consuming the food and beverages.

Conventionally, the difference in cost of food and beverages from distributor or wholesale to patron consumption at retail is meant to cover overhead costs, employee salaries, and profit to the restaurant. Unfortunately, this “difference” often in the form of multiples of the actual cost of the food and beverages comes at the great expense to the patrons/consumers, who are charged a substantial mark-up for the ordered and consumed food and beverages. The cost of food charged at many restaurants is much greater than the wholesale price charged to the restaurant. Conventionally, the cost of beverages charged to patrons at many restaurants is even greater in terms of multiples than the wholesale price charged by the wholesales/distributors of the beverages to the restaurant. These seemingly high retail charges can be prohibitive to many individuals looking to consume a meal out of one's home and at a nice restaurant, or even a moderately priced meal with an alcohol beverage included, such as a glass of wine, bottle of beer, or a martini. Restaurant prices have become very expensive, especially for higher quality foods such as steak or lobster, and it often results in a substantial and large “bill” or check for a family of four. It results in less frequent dining out by many and that, of course, impacts on the overall potential of the restaurant to operate at a profit, since many of the expenses to operate a restaurant are independent or substantially independent of some expenses, e.g., rent, chef and wait staff salaries, bus boys, property taxes, etc. Thus, a new method for operating a restaurant at a profit which may increase the profit (due to more consumers and patrons consuming food and beverage at the restaurant in comparison to those who indulged at the same restaurant if operating under the conventional manner of pricing based on a high multiple of the cost of food and beverage) is highly desirable.

The present invention provides an alternative method for charging customers for a meal, providing a potentially significantly less expensive dining experience while not compromising the quality of the food nor the service provided. If properly marketed and presented, the patrons will gladly frequent the restaurant since the cost of the meal(s) and consumed liquor seems (and is) so much less than the same meal and beverages would cost at a traditional or conventional-priced restaurant. The restaurant operating consistent with the present invention will experience huge increases in patrons, the patrons will turn-over their tables more quickly (since a component of the pricing of the meal is based on units of time at the table consuming the food and beverage) and bottom line profit will soar. This is a win-win for the patrons and the restaurant owner/operator. The only owners/operators to “suffer” will be the restaurants that continue to operate under the pricing strategy of the past—multiples of the actual cost of the food and beverages without any thought of pricing based on duration of time spent in the restaurant.

Accordingly, using the present invention, a restaurant can charge its patrons/customers basically the same or a substantially similar price which it paid at wholesale or to its distributors for the consumed food and/or drinks and add a time duration component for the length of stay that the consumer/patron consumes the food/beverage on the premises. For example, by charging patrons/diners market price for food and drinks, a fine steak at an upscale New York City restaurant which conventionally would be listed and cost $36.00 on the menu—at a restaurant operated according to the principles of the present invention may only cost the patron $9.00, and a martini which normally costs the consumer $10.00 on conventional menus may only cost that consumer $1.75 in a restaurant operated according to the present invention.

Since restaurants would not make any profit on the mere sale of food and beverage if charged to patrons at “market price” i.e., the cost of the food and beverage by the restaurant buying the same from its suppliers/distributors, an additional component is included in the patron's charges for the meal. But, rather than charging diners significantly marked-up prices for food and drinks, which often results in astronomically or relatively high expenses for the consumers, the present invention presents the added component for the meal based on the duration of time spent in the restaurant. This offers the patron a seemingly better value and encourages the patron to turn over the table, to the patron and the restaurant's benefit. The patron's charges are also based on the duration of time so that the shorter the time to consume, the lower the bill (although the initial charge for time is preferably set to allow the leisurely ordering and consumption of the food and beverages, just not excessive loitering) and the restaurant benefits from being able to serve more food and beverages to others, further justifying the new pricing model and obtaining payments for consumed meals which help support the fixed and slightly variable expenses of running a restaurant. Thus, while charging diners market price for food and beverages, a restaurant operating consistently herewith will also charge a set price per diner per unit of seated time. By doing this, diners who choose to eat quickly and not linger at the table during a meal will be charged less than diners who desirably spend a few hours at the table, whether eating, talking or relaxing and having conversation even after their meal has been consumed or finished. In using this method, the restaurant makes its profit on the time spent at the table, not on the meal itself. At the same time the patrons obtain great value whether based on solely consumed food and beverages or consumed food and beverages and time spent at the table.

By operating a restaurant in this manner, patrons/diners essentially have the opportunity to choose how much they wish to spend on a meal, without having to alter their preferred menu choices. The larger component of the cost of eating in a restaurant according to the present invention is based on time spent at the restaurant and the smaller component of the cost of the meal may be the actual cost of the food/beverages or, if not “smaller” at least the consumer feels it is smaller because that market pricing is so much lower than conventional restaurant pricing. Restaurants operating consistently with the present invention will charge a price which is based on the time usage of a table and chairs during a meal. The “seating fee” per diner can also be regulated by volume, traffic, and time of day. So, for example, in a New York City fine restaurant, each diner may be charged a $10.00 seating fee for 60 minutes at lunch time, or $15.00 for 75 minutes at dinner. Thus a group of four for dinner will pay substantial market pricing for their food and beverage consumed and $60 for the seating charge if they spend 75 minutes or less at the table for dinner. A couple for lunch at the restaurant will again spend market price for the food and beverage consumed and $20 for the 60 minutes of time spent at the table, again, assuming they spend 60 minutes or less eating and consuming the food/beverages. A fine restaurant in Omaha, Nebraska may, instead, charge a $5.00 seating fee for an hour at lunch per person and maybe $8.00 per 75 minutes at dinner time with each extra 15 minutes (lunch or dinner) having a charge (normally pro rata to the initial 60 minutes or 75 minutes charged). So, for example, in Omaha, the extra 15 minutes for dinner may add $2.00 per patron ($8 for the group of four in the example). It is an aspect of the present invention that the greater the expected traffic for the time of day and the busier the time of the meal, the higher the seating fee will be for the patrons. This will also encourage potential patrons and customers to eat “off peak” so as to reduce the principal cost component of the meal i.e., the seating fees. This, too, is to the restaurant operator's benefit as having more patrons consume food and beverage at other, non-peak hours, again helps the profitability of the restaurant.

An additional time fee can be added on per diner once the initial time period has lapsed. Thus, in the example above, if diners pay a $15.00 per person seating fee for 75 minutes at dinner hour, they will be charged a $12.00 seating fee each for one hour of time or $3.00 for each quarter hour after the initial 75 minutes has passed. In this manner, the diners themselves have the opportunity to choose how much money and time they would like to spend for dinner at the restaurant. If they opt to eat quickly, they will be charged only $15.00 per person for the initial 75 minutes. If they choose to sit for two and a quarter hours, enjoy their meal and some wine, and not rush out, they will be charged an additional $12.00 seating fee per person (four additional quarter hours at $3.00 per person per quarter hour beyond the initial 75 minutes) for a total seating charge of $27.00 a person. That still results, often, in a) a long durational and leisurely meal and b) a net savings of the meal expense in comparison to that of conventional restaurants and c) a profit component to the restaurant being made.

The present pricing methodology will allow for potentially less expensive meals for patrons at a restaurant while not compromising the quality of the food and while allowing restaurants to earn greater revenues by seating more groups of individuals over a given timeframe than would normally be possible. In the alternative, should diners make the cognizant decision to stay seated at a restaurant for a longer period of time, the restaurant can earn fees even if the patrons have finished ordering.

### DESCRIPTION OF PRIOR ART

To the Applicant and inventor's knowledge, there is no current system or method for charging restaurant patrons based on actual or near market pricing and time spent at a table as opposed to a multiple based on the food and beverage consumed. In the prior art, restaurants either charge marked-up from wholesale or distributor prices to consumers for the food and drinks purchased, or charge one set price for a meal, such as a buffet. Of course, some restaurants base their pricing on the cost of the food as the basic component to charge the patron/customer and add an amount to cover expenses and a profit margin. However, to the inventor's knowledge, no fine restaurant charges customers for their consumed meal by basing the same on the basic market price of the purchased food, as adjusted based on current market conditions, and adding a component to the same for the duration of time spent in the restaurant. The present invention presents a new method for charging customers for a meal and their consumed beverages. While customers are charged for the specific items purchased, the present invention teaches charging customers substantially the same price for the food and beverages as the restaurant paid for them, not even including a preparation or handling fee. To cover the restaurant expenses and to create a profit, customers are charged a seating fee per person per unit of time spent and depending upon time of day and possibly day of the week, seating and enjoying the fine meal at a table, and an additional fee for time spent by the patrons of the party over the initial allotted time.

Restaurants in the prior art price their food and beverages based on the cost of the same from their suppliers but including in the listed menu cost a multiple to cover for the expenses and to produce a profit. There have been restaurants that charge customers a table set up fee or a cover fee but that is usually a mechanism to defer the cost of the entertainment and to ensure that patrons do not merely occupy tables without ordering a sufficient amount of food and beverages to justify their occupation of the table, to the disadvantage of the restaurant's ability to fill the table with higher consuming patrons/customers.

To the inventor's knowledge, no method for operating a restaurant has been based on the actual, current price or cost of the food and beverage coupled with a durational seating charge per person. To the inventor's knowledge, no such restaurant provides a verification mechanism, preferably in the form of a centrally located and patron-visible “ticker” feed of the then current market price for the food. To the inventor's knowledge, there is no such verification system provided which visibly displays the cost of the food/beverage to the consumer/patron, at the time of ordering the food in the restaurant, where the cost of the food is based on a professional commodity trading business, e.g., the Chicago Board of Trade for beef pricing. Also, to the inventor's knowledge, there is no method for operating a fine restaurant consistent with the above factors for pricing a meal where the pricing is further adjusted based on the quantities then on hand in the restaurant and consumed or available. These and other aspects of the present invention are set forth herein.

### SUMMARY OF THE INVENTION

A system and comprehensive and integrated method for charging patrons for their food and beverages at a restaurant and bar, comprising providing, on a computer, including a memory, a processor, and a visual display mechanism, current market prices, i.e., food and beverage prices which are based on the prices the restaurant expended for food and drinks from its suppliers and food/beverage distributors, and/or adjusting the same based on current market conditions, i.e., the processor is adapted to update the actual market prices of specific food and drink items to then current market pricing, and wherein the visual display mechanism is adapted to display those market prices to the patrons. The market prices shown are charged to patrons buying food and beverages, and the market price is generally substantially similar to the wholesale price paid by the restaurant and bar as opposed to multiply marked-up pricing. The restaurant, instead, also charges patrons an initial seating fee, which is a set price per patron per unit of time based on the time of day and possibly also based on the day of the week/season/holiday, etc. An additional time or extra seating fee for any time after the initial unit of time expires can also be charged per person or a component based on the number of people in the group. In this way, patrons are paying based on the amount of time spent at the table and not only based on food ordered. Also, the present invention contemplates that the market pricing visibly displayed to the patrons be adjusted based on the quantity of the same “in inventory” or the desire of the restaurant to minimize waste and to push a certain food/beverage because of inventory and/or the ability to replace the same at a lower cost. These and other aspects are contemplated by the present invention.

### DETAILED DESCRIPTION AND THE PREFERRED EMBODIMENT

It will be understood by those of ordinary skill in the art that various changes may be made and equivalents may be substituted for elements and steps herein without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

The present invention discloses a method for operating a retail restaurant and bar business and specifically for using volume, timing, and market pricing to determine prices charged at a restaurant and bar to a patron for an ordered meal and/or beverage. The present invention provides a method for serving quality food and drinks at or substantially at current market cost, as determined by the pricing the restaurant paid to its distributors/suppliers and wholesalers, as opposed to charging customers multiply marked-up retail prices for food and drinks merely based on those prices and including a component for the expenses of running a restaurant and a profit margin.

The benefit of the present invention for restaurant patrons is that they have the ability to control the cost of their meal by choosing what they want to eat and drink and how long to stay in the restaurant, how many courses to order, and whether they wish to linger at the table even after the meal is over. However, if a relative short period of time is all the consumer requires at the restaurant, the cost of the meal is significantly less than conventional and the consumer feels a sense of satisfaction for paying a reasonable fee for the food and drink, and a not unreasonable fee for sitting and eating in the restaurant. An overall “feel good” feeling is generated as the consumer will not feel as if the restaurant is overcharging him/her on the actual cost of the food/beverage but, rather, is charging a more fairly determined cost of the same.

The benefit to the restaurant will result in at least one of two forms. First, a restaurant can charge the seating fee to patrons sitting at a table even while they may be done ordering and consuming food. Thus, if a table of four finishes eating dinner in New York City but continues to drink the bottle of wine which they also ordered or they just sit and talk at the table for up to but not over two hours total, the restaurant can charge an additional $36 (4 patrons which each cost $3 for each 15 minutes beyond the initial 75 minutes). This provides the restaurant with some income for the patrons continuing to sit at the table despite not ordering anything further. Under normal and common restaurant charging methods, the restaurant would not earn any further money once the patrons have finished ordering and eating, even if they choose to sit at the table.

Because the present invention teaches charging patrons based on the market price of the food and beverage and also based on time spent at a table, patrons at restaurants and bars using the present invention may be inclined to merely finish eating, a small period of sitting and not to talk and linger at the table for much time after the meal is over. Thus, the restaurant can increase its income and possible profits under the present invention by seating more customers at a given table over the span of a given time, with sets of patrons utilizing the table for consistently likely less time. Thus, a group of four customers may sit at a table and eat their meal, taking a total of forty-five minutes. When that group gets up from the table, a new group of four customers may sit down. Using the present invention, the restaurant can charge the $15 per person seating fee to two groups of patrons over the same time span that a single group may normally sit at a table, even after having finished eating.

The present invention teaches charging current or recently purchase price costing for food and beverages, as opposed to multiply marked-up retail prices as is conventionally done. The costs of the food and beverages are based on the cost to the restaurant for the same, as they have purchased the same from their wholesalers, suppliers and distributors. These prices may, however, fluctuate and be adjusted, as the consumer(s) are about to order (but once ordered the pricing is “locked in” up or down, based on current market conditions). Preferably, these current market conditions are visibly provided to the consumers by an overhead or on the table ticker or LED scrawl-like menu system, even more preferably, directly linked to a known and high-integrity market exchange, for example, the Chicago Board of Trade for cattle pricing. Also, the pricing of the food and beverage can be further adjusted, as desired by the restaurant and bar owners/operators by their changes to the pricing based on current inventory of the food and beverage and their desire to “move” the same or to discourage ordering of the same (say if they are running quickly out of shrimp, for example). The pricing of the food and beverages is primarily based on the above factors and these are generally significantly less than the pricing of the same where the restaurant would charge the consumer based on the cost of the food, adjusted for the expenses of the restaurant and the profit margin, resulting in many multiples of the actual cost of the food/beverage.

Whereas a restaurant may normally charge $8.00 for a salad whether a head of lettuce costs $1.29 or $1.35, prices according to the present invention may fluctuate up or down based on current market costs but are actually based primarily on the cost of the head of lettuce. Thus, if the price of a certain product should drop due to a surplus in the market, the price charged for that item in the restaurant will be reflected on the LED or other monitor/screen/display to lower as well. Alternatively, if the price of an item should increase due to a shortage, say, because of weather conditions affecting growth, the price for that item in the restaurant operating consistently with the present invention will increase as well. Thus, while the price of food or drinks may vary each time individuals dine at a restaurant operating accordingly, the individuals will know that they are always paying current market price for the items selected off the menu. This leads to a better feeling about the restaurant and leads to consumer loyalty and repeat customers, the hallmark of a highly successful restaurant and to profitability.

In one example, if a couple chooses to go out to dinner at a currently conventional or traditional fine steak house using pricing of the industry prior to the present invention, they may pay the following prices for a meal: $8.50 for a Caesar salad; $16.00 for a lobster cocktail; $34.00 for a filet mignon; $29.00 for grilled tuna; $6.00 for a baked potato; $9.00 for a side order of fried potatoes or vegetables; $16.00 for two margaritas; and $18.00 for two martinis, for a total of $136.50 (without tip or taxes). Using the present invention, the same meal would have a cost to the couple, to be added to the seating cost, at the following prices: $2.00 for a Caesar salad; $7.00 for a lobster cocktail; $15.50 for a filet mignon; $10.55 for grilled tuna; $1.00 for a baked potato; $1.75 for a side order of potatoes or vegetables; $3.00 for two margaritas; and $3.20 for two martinis, for a total of $44.00 (without tip nor taxes). Under the present invention, the restaurant would also charge a seating fee of, for example, $15 per person for the 75 minutes. Thus, adding $30 for the two individuals to the price of the meal and beverages, the patrons will pay, for the same meal, $74.00 as opposed to $136.50. This represents a savings of $62.50 to the patrons/customers who get to enjoy a nice meal out for almost half the price it would normally cost. If they decide to linger at the table, each 15 minutes may cost them a combined $6 (assuming nothing further is consumed). A great deal for the consumer and $30 or $36 going towards the expenses of the restaurant and its profitability. The incentive for the diners to leave after consuming is important to the restaurant's table turn over as that is important to bottom line profitability as seating charges are of prime importance to this model of restaurant operation. Of course, if the couple wants dessert and/or coffee, they will again pay market pricing, say $1.50 for a slice of apple pie (in contrast to $8 charged at a fine restaurant operating under the traditional model of pricing; maybe 75 cents for a cup of coffee vs. $4 at the steak house, etc.)

but the couple will possibly pay and the restaurant thus earn an additional sum for the extra time spent, say 15 minutes for dessert, resulting in another $6 total for the two consumers.

Of course, as suggested, the pricing can be adjusted based on other factors, including time of day, day of week, quantity of food on hand, changing market pricing as set forth by the established trade or a local grocery, etc. The pricing will be shown on available and visible monitors, on a changeable chalkboard (for ambience and excitement if, for example, the cost of shrimp or lobster is suddenly “slashed” from $6 per pound to $4) on a ticker tape like display near the bar, to a display on the table, etc. Once the order of the diners is placed with the service provider (waiter or waitress or automatic ordering system, for example) the time of the order is recorded and the pricing then set. That, too, can be the initiation of the duration of time for waiting for food and beverage consumption so that the diners do not feel as if the restaurant is taking advantage of the seating fees by being slow to “take one's order.” Or, the restaurant can either provide a built in, for example, 15 or 25 minutes of ordering, cooking and serving time. Also, the restaurant can post and provide a 5 or 10 minute “leeway” such that the additional seating time does not commence until that short leeway first expires, to account for slowness of staff, cooking, waiting for the food, etc.

In a second example, if a couple decided to go out to an “expensive” dinner to celebrate their anniversary, they may pay the following prices for a meal at a well-established, high end steakhouse: $18.00 for crabmeat cocktail; $12.00 for oysters; $34.00 for filet mignon; $38.00 for a lobster; $10.00 for a side of potatoes; $9.00 for a piece of cake; and $550.00 for two bottles of Dom Perignon to celebrate the occasion. The total cost of this meal would be $671.00 using conventional restaurant pricing. Using the present invention, these two customers may pay the following for the same meal at a similarly appointed restaurant, the only difference being the pricing and operational mode: $7.50 for crabmeat cocktail; $5.50 for oysters; $15.50 for filet mignon; $18.00 for a lobster; $2.00 for a side of potatoes; $3.00 for a piece of cake; and $270.00 for two bottles of Dom Perignon (at the restaurant's cost). Under the present invention method, this same dinner, for the food and beverages, would cost $321.50. When adding a $15.00 per person seating fee for the first 75 minutes, plus a $12.00 per person fee for the next hour, for example, the total cost for the meal comes to $375.50 and their stay at the restaurant is quite pleasurable, extending for 2 hours and 15 minutes. This represents a savings of nearly $300.00!

Restaurants operating consistent with the present inventive method may enjoy longer lines and more frequent dining by repeat customers who desire the opportunity to obtain the same meal as they would in any fine restaurant for about half the price. Customers often wait in long lines for restaurants with excellent reputations and with high quality food. Using the present invention, restaurants may see higher increases in customer dining frequency, less table vacancies, more table turnover and more profitability, all without any real disadvantage to the consumers. Indeed, the patrons/customers will likely be thrilled with the new costing/pricing, in comparison to the traditional pricing of similar fine steak houses. Additionally, because customers may want to avoid additional time charges, it is likely that customers may choose to eat at a quicker pace, order fewer courses, and leave the table sooner after finishing their meal, as opposed to sitting at the table for long periods of time without ordering anything further. This, too, inures to the restaurant's benefit, of course. And, yet, if the consumers decide to linger and have dessert, coffee, an after dinner drink, they will pay at market pricing for the same, pay an additional seating fee, too, all to their delight and to the bottom line profitability of the restaurant.

Using the method of the present invention, customers and patrons can enjoy high quality meals at significantly reduced and lower prices, and the patrons control the overall price they will pay based on what they order, of course, and how long they choose to spend at the restaurant. The restaurants, meanwhile, can enjoy greater attendance, frequent table turnover, less vacancy of tables at non-peak times, and longer lines, while also seeing customers eat and leave the table in a faster pace than previously seen. This will allow the restaurants using the present invention to seat more customers over a given time frame, as most groups of diners will likely not linger long after the meal ends. And, of course, the seating fees will add to the bottom line of the restaurant/bar.

While the prices for food can fluctuate based on market demand, the seating fees can also vary based on time of day, day of the week, season, month, or time of the year. For example, a restaurant may only charge a $10 seating fee per person for lunch, while charging a $15 seating fee per person for dinner. Similarly, a restaurant may increase the seating fee to $20 per person at busy times, such as around Christmas and New Years Eve or Day, or on Valentines Day. Alternatively, during certain times of the year, restaurants may leave the seating fee at the same price, while reducing the time period which it covers. So, in the example above, a restaurant may choose, during Holiday season, to charge a $15.00 fee per person for dinner for 60 minutes as opposed to 75 minutes. The extra seating time charge can also be varied by the owners, as desired, all to maximize profitability. Group seating can be adjusted, too. So, for example, maybe 4 people will each cost $10 per 60 minutes for lunch but a fifth person is “for free” for the group. Or, maybe the fifth person actually costs the group $12 for a total cost for the 60 minutes of lunch of $52. Flexibility for the owner is maintained, if desired.

While per seat pricing is based on time of day, day of week, season, nearness to an event (local theater, concert, ballet, etc.) and resembles the method by which restaurants usually increase their prices for food during “peak” times of the year, using the present invention, the cost of the food and beverage is independent of the time of day, year, season, event, etc. but is market price dependent, i.e., it does not change except if the cost to replace the same changes, with the exception of increases or decreases in the market value and/or the inventory and availability to serve the same in the restaurant.

In order to track and alert customers as to current market conditions, the present invention comprises an automated ticker tape-like menu and price providing device, a large overhead (or over-the-bar) monitor, a monitor/menu on each table, a chalkboard, etc. which displays the menu and/or those items which have on the fly changing pricing based on the pricing of the same by an established and high integrity standard, say, the Chicago Board of Trade for meat products. The computer for operating the monitors can be linked to the output of the market maker. The computer for driving the monitor may comprise a memory (for the changeable menu items), a processor (for updating and showing the changes of the pricing and the time of the change), and a viewable screen to the consumers/patrons, those waiting and those at the tables. The automated ticker is adapted to update market conditions of various food and beverage items. The ticker may be updated in real time, as market prices are determined, or may be up to date within the hour, the day, or the week, depending on how often prices fluctuate within the market maker. As prices are determined, they can be received by the processor of the computer-based ticker system, pricing updated and stored in the memory, and then displayed on the screen for viewers to see (maybe green new pricing to denote a price rise and red to denote a price cut, or vice versa). This way, viewers can know just before ordering whether the price of a certain item on the menu is more or less expensive on a given day or at a time. This method also is expected to be enjoyable and fun, adding a feeling of newness to the dining experience, similar to that first occasioned by eating at a theme restaurant, e.g., Planet Hollywood; Hard Rock Cafe, etc. People flocked to them for the experience even though they were serving and pricing quite conventional fare. Here, however, it is expected that people will also flock to these new restaurants for the perceived bargain and better value pricing, for the newness of the concept, for the feeling of value, and the excitement of eating at a restaurant where the actual pricing for the food and beverages reflect actual market pricing.

Normally, restaurants give each diner a menu with a list of prices for each dish offered. One embodiment of the present invention comprises use of the present invention with a traditional menu. In this embodiment, the present invention can utilize, on the viewable screen, an indication that a certain item, say beef, has increased or decreased in value, by means of an “up” or “down” arrow, or a color-coordinated system. This will give a similar indication to patrons that a price has changed.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed:

1. A method for operating a restaurant and/or bar, comprising:
providing a menu for food and/or beverages with pricing based on both market prices for the ordered food and beverage and charging patrons an initial seating fee, wherein said initial seating fee is a set price per patron per unit of time.

2. The method for operating a restaurant and/or bar as claimed in claim 1, further comprising charging a first additional time seating fee per patron for a first extra amount of time which is pro rated to said initial seating fee per'patron per unit of time.

3. The method for operating a restaurant and/or bar as claimed in claim 2, further comprising charging a second additional time seating fee per patron for a second extra amount of time which is proportionally greater per person per unit of time than said set price per patron per unit of time or said first additional time seating fee per patron for said first extra amount of time.

4. The method for operating a restaurant and/or bar as claimed in claim 1 further comprising changing a first additional time seating fee per patron for a first extra amount of time which is proportionally greater than said initial seating fee per patron per unit of time.

5. The method for operating a restaurant and/or bar as claimed in claim 2, wherein said first additional time seating fee is equal to or less than said initial seating fee per patron per unit of time.

6. The method for operating a restaurant and/or bar as claimed in claim 1, wherein said market price for food and beverage fluctuates and is provided to patrons of said restaurant, based on current market conditions, just prior to said patrons ordering the same.

7. The method for operating a restaurant and/or bar as claimed in claim 6, wherein said fluctuations of market price is provided to said patrons by a computer system comprising a memory means, a processor and a visual display for said patrons of said restaurant.

8. The method for operating a restaurant and/or bar as claimed in claim 7 wherein said memory of said computer is adapted to update said market prices in real time by use of said processor and to display the same on said visual display.

9. The method for operating a restaurant and/or bar as claimed in claim 1, wherein said initial seating fee is based on time of day.

10. The method for operating a restaurant and/or bar as claimed in claim 1, wherein said initial seating fee is based on any one or more of the following: time of day, day, month, season, proximity to an event, or Holiday.

11. The method for operating a restaurant and/or bar as claimed in claim 1, wherein said initial seating fee is based on inventory of said food and/or beverage within the restaurant.

12. A system for charging patrons for consuming an item of food and/or beverage at a restaurant and/or bar, comprising:
a computer, serving as a menu for said items of food and/or beverages including a memory, a processor, and a visual display mechanism, wherein said processor is adapted to display market prices for at least one of said items of food and drinks;
an initial period of time seating fee, wherein said initial period of time seating fee is a set price charged by said restaurant per patron per initial unit of time; and
one or more additional time seating fees per patron for an extra amount of time above said initial unit of time; and
wherein said restaurant and/or bar charges said patrons for said market prices for food and/or beverages, said market price being the same as or substantially close to the actual price paid by the restaurant for said item of food and/or beverage.

13. The system for charging patrons for consuming an item of food and/or beverages at a restaurant and/or bar as claimed in claim 11, wherein said one or more additional time seating fees is equal to or less than said initial period of time seating fee.

14. The system for charging patrons for consuming an item of food and/or beverages at a restaurant and/or bar as claimed in claim 11, wherein said market price for food and drink is adapted to fluctuate based on substantially current market conditions.

15. The system for charging patrons for consuming an item of food and/or beverages at a restaurant and/or bar as claimed in claim 11, wherein said computer is adapted to update said market pricing in substantial real time.

16. The system for charging patrons for consuming an item of food and/or beverages at a restaurant and/or bar as claimed in claim 11, wherein said computer is networked to an exchange or trading system for sellers and buyers of the same.

17. The system for charging patrons for consuming an item of food and/or beverages at a restaurant and/or bar as claimed in claim 11, wherein said initial period of time seating fee is based on any one or more of the following: time of day, day of week, season, proximity to an event in the neighborhood, Holiday or occasion.

18. The system for charging patrons for consuming an item of food and/or beverages at a restaurant and/or bar as claimed in claim 11, wherein said initial period of time seating fee is based on geographic location of said restaurant.
